(19) United States
(12) Patent Application Publication
(10) Pub. No.: US 2025/0390037 A1
(43) Pub. Date: Dec. 25, 2025

(54) FIXING DEVICE

(71) Applicant: CANON KABUSHIKI KAISHA, Tokyo (JP)

(72) Inventors: HIROKI KAWAI, Chiba (JP); SHOHEI TSUZAKI, Chiba (JP); MISA KAWASHIMA, Chiba (JP); IKUO NAKAMOTO, Chiba (JP)

(21) Appl. No.: 19/241,231

(22) Filed: Jun. 17, 2025

(30) Foreign Application Priority Data
Jun. 24, 2024 (JP) 2024-101224

(51) Int. Cl. G03G 15/20

(52) U.S. Cl. CPC G03G 15/2025; G03G 15/2028; G03G 15/2064; G03G 2215/00413; G03G 2215/2025

(57) ABSTRACT

A fixing device includes a belt a rotation member, and a nip formation member, wherein the nip formation member includes a sliding member, wherein the sliding member includes a base member and a sliding portion having a plurality of protrusions, a first region that is a surface where the sliding portion including the plurality of protrusions is provided at a center part of the sliding member in a longitudinal direction, and a second region that is a surface same as the base member of the first region, disposed outside the first region in the longitudinal direction, and not including the sliding portion, and wherein, in a conveyance direction of the recording medium, an upstream end at a first position in the first region is positioned upstream of an upstream end at a second position in the second region.

### BACKGROUND

### Field

The present disclosure relates to a fixing device.

### Description of the Related Art

An image forming apparatus includes a fixing device that fixes a toner image onto a recording medium by applying heat and pressure to the recording medium on which the toner image has been formed. The fixing device includes an endless fixing belt that rotates, a fixing pad disposed to be non-rotatable on an inner peripheral side of the fixing belt, and a pressing roller abutting on an outer peripheral surface of the fixing belt. In the fixing device, the fixing pad is pressed by the pressing roller to form a fixing nip portion. When the recording medium is held and conveyed by the fixing nip portion, toner borne on the recording medium is fixed to the recording medium by heat and pressure.

When frictional force between the fixing belt and the fixing pad is large, rotation of the fixing belt is hindered. Therefore, to reduce the frictional force between the fixing belt and the fixing pad, Japanese Patent Application Laid-Open No. 2023-125019 discusses a device provided with a sliding member including a plurality of protrusions that slide over the fixing belt on the inner peripheral side of the fixing belt.

### SUMMARY

According to some embodiments, a fixing device includes a belt configured to be rotatable and endless, a rotation member configured to abut on an outer peripheral surface of the belt, and a nip formation member provided on an inner peripheral surface of the belt to interpose the belt between the nip formation member and the rotation member, and configured to form a nip portion, the nip portion fixing a toner image to a recording medium by applying heat and pressure while holding and conveying the recording medium on which the toner image is formed, wherein the nip formation member includes a sliding member that slides over the belt, on a surface coming into contact with the inner peripheral surface of the belt, wherein the sliding member includes a base member and a sliding portion in which a plurality of protrusions protruding from the base member slides over the inner peripheral surface of the belt, a first region that is a surface where the sliding portion including the plurality of protrusions protruding from the base member is provided at a center part of the sliding member in a longitudinal direction, and a second region that is a surface same as the base member of the first region, disposed outside the first region in the longitudinal direction, and not including the sliding portion, and wherein, in a conveyance direction of the recording medium, an upstream end at a first position in the first region is positioned upstream of an upstream end at a second position in the second region.

Further features of the present disclosure will become apparent from the following description of exemplary embodiments with reference to the attached drawings.

### BRIEF DESCRIPTION OF THE DRAWINGS

FIG. 1 is a schematic diagram illustrating an image forming apparatus that suitably uses a fixing device according to an exemplary embodiment.

FIG. 2A is a schematic diagram illustrating the fixing device, and FIG. 2B is a cross-sectional view illustrating a fixing belt, a pressing roller, and a fixing pad unit.

FIG. 3A is a schematic diagram illustrating a sliding member, and FIG. 3B is a top view illustrating the sliding member.

FIG. 4 is a cross-sectional view illustrating a vicinity of a fixing nip portion according to the present exemplary embodiment.

FIGS. 5A and 5B are cross-sectional views illustrating a vicinity of an entrance of a fixing nip portion in abutting and released states in a case where no step is provided according to comparative example.

FIGS. 6A and 6B are cross-sectional views illustrating a vicinity of an entrance of the fixing nip portion in abutting and released states in a case where a step is provided according to present exemplary embodiment.

FIG. 7A is a diagram illustrating a longitudinal layout of the sliding member including cutout parts as viewed from a lower side in a pressing direction of a fixing pad according to the present exemplary embodiment, and FIG. 7B is an enlarged view of an end part in a longitudinal direction of the sliding member including a cutout part.

FIG. 8 is a partial perspective view illustrating positional relationship and shapes of the fixing pad and the sliding member including the cutout part according to the present exemplary embodiment.

FIG. 9 is a graph illustrating relationship of a proximity distance between the fixing belt and a corner of the sliding member according to the present exemplary embodiment.

FIG. 10 is a diagram illustrating a durability evaluation result for confirmation of an effect according to the present exemplary embodiment.

FIG. 11 is a partial perspective view illustrating a case where a sliding member includes cutout parts on both of an upstream side and a downstream side according to a modification of the present exemplary embodiment.

FIG. 12 is a diagram illustrating an example in a case where one cutout part of a sliding member includes a plurality of cutout amounts according to another modification of the present exemplary embodiment.

### DESCRIPTION OF THE EMBODIMENTS

Various exemplary embodiments, features, and aspects of the present disclosure are described below with reference to the drawings. While the exemplary embodiments represent examples of the best mode of the disclosure, the present disclosure is not limited to these examples.

### <Image Forming Apparatus>

An image forming apparatus 1 is an electrophotographic full-color printer including four image forming units Pa, Pb, Pc, and Pd provided corresponding to four colors of yellow, magenta, cyan, and black. In the present exemplary embodiment, the image forming apparatus 1 is of a tandem type in which the image forming units Pa, Pb, Pc, and Pd are arranged in a rotation direction of an intermediate transfer belt 204 described below. The image forming apparatus 1 forms a toner image (image) on a recording medium, based on an image signal from a document reader 2 connected to an apparatus main body 3 of the image forming apparatus 1 or from a host apparatus, such as a personal computer, connected to the apparatus main body 3 to communicate with each other. As the recording medium, a sheet medium, such as a sheet, a plastic film, and a cloth is usable.

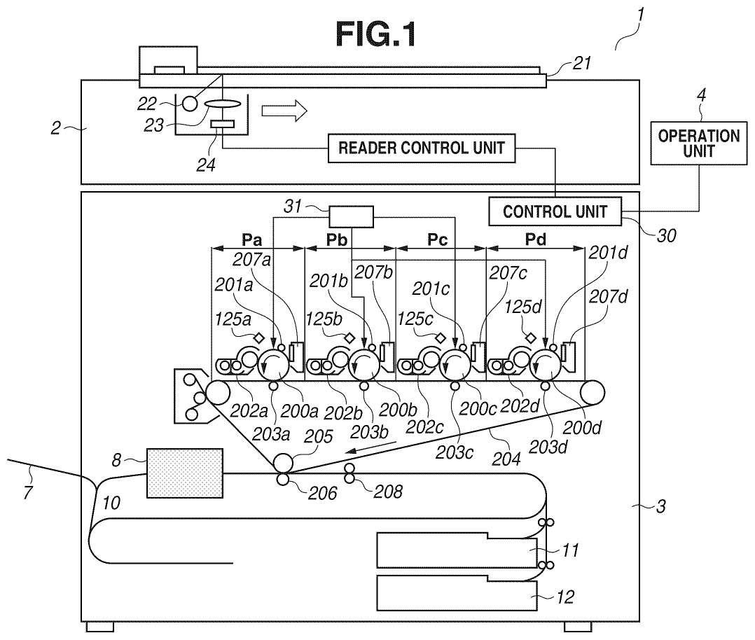

As illustrated in FIG. 1, the image forming apparatus 1 includes the document reader 2 and the apparatus main body 3. The document reader 2 reads a document placed on a document platen glass 21. Light emitted from a light source 22 is reflected by the document, and an image of the light is formed by a charge coupled device (CCD) sensor 24 through an optical member 23, such as a lens. Such an optical system unit converts the document into an electric signal data stream by scanning the document line by line in an arrow direction under control of a reader control unit. The image signal obtained by the CCD sensor 24 is transmitted to the apparatus main body 3 and is subjected to image processing corresponding to each image forming unit described below by a control unit 30. The control unit 30 receives external input as the image signal from an external host apparatus, such as a print server.

The apparatus main body 3 includes the plurality of image forming units Pa, Pb, Pc, and Pd, and each of the image forming units Pa, Pb, Pc, and Pd performs image formation based on the above-described image signal. In other words, the image signal is converted into a laser beam subjected to pulse width modulation (PWM) control by the control unit 30. A polygon scanner 31 serving as an exposure device performs scanning with the laser beam corresponding to the image signal. As a result, the laser beam is applied to photosensitive drums 200a to 200d serving as image carriers for the respective image forming units Pa to Pd.

The image forming unit Pa forms a toner image of yellow (Y), the image forming unit Pb forms a toner image of magenta (M), the image forming unit Pc forms a toner image of cyan (C), and the image forming unit Pd forms a toner image of black (Bk). The image forming units Pa to Pd have a substantially same configuration. Therefore, the image forming unit Pa for forming the toner image of yellow (Y) is described below as an example, and description of the other image forming units Pb to Pd is omitted. In the image forming unit Pa, the toner image is formed on a surface of the photosensitive drum 200a, based on the image signal as described below.

A charging roller 201a serving as a primary charger charges a surface of the photosensitive drum 200a to a predetermined potential, to prepare electrostatic latent image formation. An electrostatic latent image is formed on the surface of the photosensitive drum 200a charged to the predetermined potential, by the laser beam from the polygon scanner 31. A developing unit 202a develops the electrostatic latent image on the photosensitive drum 200a to form a toner image. A primary transfer roller 203a transfers the toner image on the photosensitive drum 200a onto the intermediate transfer belt 204 by performing discharge from a back surface of the intermediate transfer belt 204 to apply a primary transfer bias of a polarity opposite to a polarity of toner. The surface of the photosensitive drum 200a after transfer is cleaned by a cleaner 207a.

The toner image on the intermediate transfer belt 204 is conveyed to a subsequent image forming unit, the toner images of the respective colors formed by the image forming units are sequentially transferred in order of Y, M, C, and Bk, and a four-color image is accordingly formed on the surface of the intermediate transfer belt 204. The toner image having passed through the image forming unit Pd for Bk positioned on the most downstream side in the rotation direction of the intermediate transfer belt 204 is conveyed to a secondary transfer portion configured by a secondary transfer roller pair 205 and 206. At the secondary transfer portion, a secondary transfer electric field of a polarity opposite to a polarity of the toner image on the intermediate transfer belt 204 is applied. As a result, the toner image is secondarily transferred from the intermediate transfer belt 204 to the recording medium.

The recording medium is stored in a cassette 11 or 12. The recording medium fed from the cassette 11 or 12 is conveyed to a registration portion 208 configured by a pair of registration rollers, for example, and stands by at the registration portion 208. Thereafter, the registration portion 208 is subjected to timing control to align the toner image on the intermediate transfer belt 204 and a position of the recording medium and conveys the recording medium to the secondary transfer portion.

The recording medium to which the toner image has been transferred at the secondary transfer portion is conveyed to a fixing device 8, and the toner image borne on the recording medium is fixed to the recording medium by being heated and pressurized by the fixing device 8. The recording medium having passed through the fixing device 8 is discharged to a discharge tray 7. In a case where images are formed on both surfaces of the recording medium, after transfer and fixing of the toner image to a first surface (front surface) of the recording medium, the recording medium is turned upside down through a reverse conveyance unit 10, transfer and fixing of a toner image to a second surface (rear surface) of the recording medium are performed, and the resultant recording medium is discharged to the discharge tray 7.

The control unit 30 controls the whole of the image forming apparatus 1 as described above. The control unit 30 also performs various kinds of settings and the like based on input from an operation unit 4 included in the image forming apparatus 1. The control unit 30 described above includes a central processing unit (CPU), a read only memory (ROM), and a random access memory (RAM). The CPU controls each unit while reading out a program corresponding to a control procedure stored in the ROM. The RAM stores work data and input data, and the CPU performs control by referring to the data stored in the RAM, based on the above-described program and the like.

### <Fixing Device>

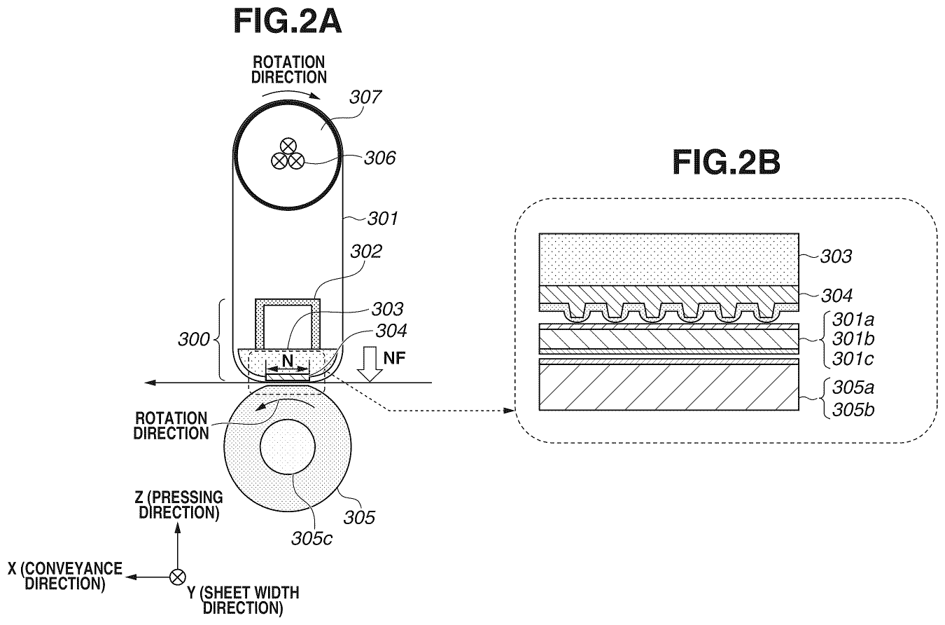

A configuration of the fixing device 8 according to the present exemplary embodiment is described with reference to FIGS. 2A and 2B to FIG. 4.

In the present exemplary embodiment, a fixing device of a belt heating type using an endless belt is adopted. As illustrated in FIG. 2A, in the fixing device 8, the recording medium is conveyed from right to left (in X direction indicated by an arrow). In the present specification, a width direction (longitudinal direction) indicates a direction (transverse direction) intersecting a conveyance direction of the recording medium at a fixing nip portion N, in other words, a rotation axis direction of a pressing roller 305 serving as a rotation member.

The fixing device 8 includes a heating roller 307 serving as a rotating member, a fixing belt 301 that is rotatable and endless, the pressing roller 305 serving as a counter member that abuts on the fixing belt 301 and forms the fixing nip portion N together with the fixing belt 301, and a fixing pad unit 300.

### <Fixing Belt>

The fixing belt 301 is provided to be replaceable on the fixing pad unit 300. The fixing belt 301 has heat conductivity, heat resistance, and the like, and is formed in a thin cylindrical shape. In the present exemplary embodiment, as illustrated in FIG. 2B, the fixing belt 301 has a three-layer structure in which a base layer 301a is provided on an inner peripheral side, an elastic layer 301b is provided on an outer periphery of the base layer 301a, and a releasing layer 301c is further provided on an outer periphery of the elastic layer 301b.

As an example, the base layer 301a has a thickness of 80 micrometers (μm), and is made of a polyimide (PI) resin.

The elastic layer 301b has a thickness of 300 μm and is made of silicone rubber. The releasing layer 301c has a thickness of 30 μm and is made of a tetrafluoro-ethylene-perfluoro alkoxy ethylene copolymer resin (PFA). An outer diameter of the fixing belt 301 is set to, for example, 150 millimeters (mm). The fixing belt 301 described above is stretched by the heating roller 307 and the fixing pad unit 300.

### <Pressing Roller>

As illustrated in FIG. 2A, the pressing roller 305 is rotatably supported by a fixing frame (not illustrated) of the fixing device 8. A gear (not illustrated) is fixed to one end part of the pressing roller 305 in the width direction. The pressing roller 305 is connected to a driving source (not illustrated), such as a motor, via the gear and is rotationally driven. When the pressing roller 305 is rotated, rotation force of the pressing roller 305 is transferred to the fixing belt 301 by frictional force generated on the fixing nip portion N. In the above-described manner, the fixing belt 301 is driven to rotate by the pressing roller 305.

The pressing roller 305 includes an elastic layer 305b on an outer periphery of a rotary shaft 305c, and a releasing layer 305a is provided on an outer periphery of the elastic layer 305b. As an example, the rotary shaft 305c is made of stainless steel (SUS) having a diameter of 72 mm. The elastic layer 305b is made of conductive silicone rubber having a thickness of 8 mm. The releasing layer 305a is made of PFA having a thickness of 100 μm.

As illustrated in FIG. 2A, the pressing roller 305 abuts on an outer peripheral surface of the fixing belt 301 in such a manner that the fixing belt 301 is interposed between the pressing roller 305 and a sliding member 304 described below, and forms the fixing nip portion N that holds and conveys the recording medium in the conveyance direction (in X direction indicated by the arrow) to fix the toner image to the recording medium. To do so, the pressing roller 305 is pressed against the fixing pad unit 300 via the fixing belt 301 by a driving source (not illustrated). In the present exemplary embodiment, the pressing roller 305 abuts on the fixing belt 301 in such a manner that, for example, pressure (NF) at the fixing nip portion N is 1600 newtons (N), a length of the fixing nip portion N in the conveyance direction is 24.5 mm, and a length of the fixing nip portion N in the width direction is 326 mm.

When the pressing roller 305 is similarly moved by the driving source (not illustrated), the pressing roller 305 is separated from the fixing belt 301 to release the fixing nip portion N. In a case where the recording medium is not caused to pass through the fixing nip portion N, the pressing roller 305 is separated from the fixing belt 301 to avoid temperature rise in the pressing roller 305.

### <Heating Roller>

The heating roller 307 is described with reference to FIG. 2A.

The heating roller 307 is disposed on the inner peripheral side of the fixing belt 301 and stretches the fixing belt 301 together with the fixing pad unit 300. The heating roller 307 is made of a metal, such as aluminum and stainless steel, in a cylindrical shape, and halogen heaters 306 serving as a heating source heating the fixing belt 301 are disposed inside the heating roller 307. The heating roller 307 is heated to a predetermined temperature by the halogen heaters 306.

In the present exemplary embodiment, in terms of heat conductivity, the heating roller 307 is made of, for example, an aluminum pipe having a thickness of 1 mm, and a surface layer is subjected to alumite treatment. The number of halogen heaters 306 may be one, however, in consideration of easiness of temperature distribution control of the heating roller 307 in the rotation axis direction (width direction), a plurality of halogen heaters 306 is desirably provided. The plurality of halogen heaters 306 has light distributions different from each other in the width direction, and a lighting ratio between the plurality of halogen heaters 306 is controlled by the control unit 30 (see FIG. 1) based on a size of the recording medium. In the present exemplary embodiment, three halogen heaters 306 are disposed. The heating source is not limited to the halogen heater, and the other heater, such as a carbon heater, may be used as long as the heating source is able to heat the heating roller 307.

In the present exemplary embodiment, the heating roller 307 has a rotation center in a vicinity of one end or a center in the rotation axis direction (width direction) and is swinged to generate a tension difference between one side and the other side in the width direction of the fixing belt 301, whereby the fixing belt 301 is moved in the width direction. The fixing belt 301 may be deviated to any end part in the width direction during rotation (so-called belt deviation) depending on outer diameter accuracy of the heating roller 307 stretching the fixing belt 301 or alignment accuracy between the fixing belt 301 and a fixing pad 303 described below. Therefore, by swinging the heating roller 307 as steering control, the position (deviated position) of the fixing belt 301 in the rotation axis direction is controlled. The heating roller 307 is urged by a spring supported by a frame (not illustrated) of the fixing device 8, and also functions as a tension roller applying predetermined tension to the fixing belt 301. In the present exemplary embodiment, the heating roller 307 performs swinging for controlling belt deviation and tension application, but another roller having such functions may be added.

### <Fixing Pad Unit>

The fixing pad unit 300 is described with reference to FIGS. 2A and 2B to FIG. 4.

The fixing pad unit 300 includes a fixing stay 302, the fixing pad 303, and the sliding member 304 that are disposed on the inner periphery side of the fixing belt 301. The fixing stay 302 is a rigid member that is made of, for example, a metal and extends in the width direction along the fixing belt 301, and supports the fixing pad 303 at a position close to the pressing roller 305. In the present exemplary embodiment, at least the fixing pad 303 and the sliding member 304 are collectively referred to as a nip formation member.

In the present exemplary embodiment, the pressing roller 305 presses the fixing pad 303 supported by the fixing stay 302 from an outer peripheral side of the fixing belt 301. As a result, the fixing nip portion N having a wide nip in which the length in the conveyance direction and the length in the width direction of the fixing belt 301 are secured is formed between the pressing roller 305 and the fixing belt 301. By supporting the fixing pad 303 made of resin by the fixing stay 302 made of metal having large rigidity, a deflection generated on the fixing pad 303 caused by pressure in pressing is reduced, and a uniform fixing nip width in the width direction is obtained.

### <Fixing Pad>

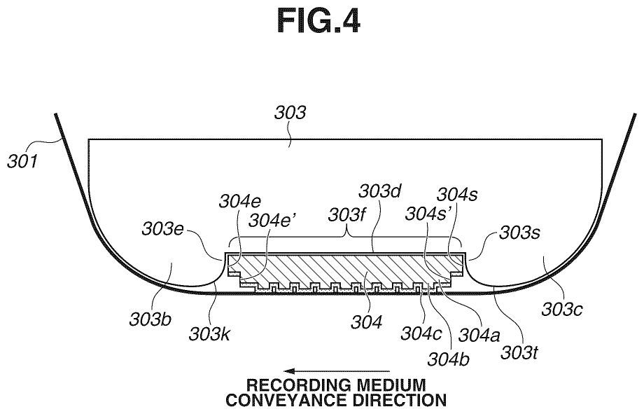

The fixing pad 303 serving as a holding member is provided to be non-rotatable on the inner peripheral side of the fixing belt 301. The fixing pad 303 includes a fitting groove portion 303f (see FIG. 4) into which the sliding member 304 having a long shape is fitted, and holds the sliding member 304 to bring the sliding member 304 into contact with an inner peripheral surface of the fixing belt 301. The fixing pad 303 is a resin member extending in the width direction, and a length in the width direction of the fixing pad 303 is longer than a length in the width direction of the recording medium having a maximum image formable size. The fixing pad 303 is made of a resin high in insulation property and heat resistance, such as a liquid crystal polymer (LCP) resin. The fixing pad 303 is a resin molded product manufactured by injection molding using a mold.

As illustrated in FIG. 4, the fixing pad 303 includes an upstream-side guide portion 303c and a downstream-side guide portion 303b. The upstream-side guide portion 303c abuts on the fixing belt 301 on an upstream side of a bottom surface 303d of the fitting groove portion 303f in the conveyance direction. An upstream abutting portion 304s of the base member 304a of the sliding member 304 abuts on an upstream side surface 303s that is provided to the fixing pad 303 and is upstream from the fitting groove portion 303f. The upstream side surface 303s of the fixing pad 303 is provided continuously from the upstream-side guide portion 303c with a corner 303t having an arc shape in between. The downstream-side guide portion 303b abuts on the fixing belt 301 on a downstream side of the bottom surface 303d in the conveyance direction. The bottom surface 303d is a surface in contact with a surface opposite to a sliding surface (front ends of protrusion portions) of the sliding member 304. The upstream-side guide portion 303c guides the fixing belt 301 toward the fixing nip portion N, and the downstream-side guide portion 303b guides the fixing belt 301 after passing through the fixing nip portion N, toward the fixing stay 302 to move the fixing belt 301 away from the fixing nip portion N. In the width direction, the upstream-side guide portion 303c and the downstream-side guide portion 303b abut on the fixing belt 301 over an entire sheet passing region where the recording medium having the maximum image formable size passes at the fixing nip portion N.

### <Sliding Member>

If frictional force between the fixing belt 301 and the fixing pad 303 is large, rotation of the fixing belt 301 is hindered. Thus, in the present exemplary embodiment, as illustrated in FIG. 4, to reduce the frictional force between the fixing belt 301 and the fixing pad 303 at the fixing nip portion N where pressure is high, the sliding member 304 sliding over the fixing belt 301 is provided to the fixing pad 303. The sliding member 304 is disposed at a position facing the pressing roller 305 with the fixing belt 301 interposed between the sliding member 304 and the pressing roller 305 in a state of being held by the fixing pad 303. In the present exemplary embodiment, the sliding member 304 is held by the fixing pad 303 in such a manner that a transverse direction of the sliding member 304 is coincident with the conveyance direction.

The sliding member 304 has heat resistance and strength, and has a sliding surface that abuts on the inner peripheral surface of the fixing belt 301 in rotation and slides over the fixing belt 301 in the state of being held by the fixing pad 303.

By interposing the sliding member 304 between the fixing pad 303 and the fixing belt 301, the frictional force between the fixing pad 303 and the fixing belt 301 is reduced, and the fixing pad 303 does not hinder rotation of the fixing belt 301. A lubricant may be applied to the inner peripheral surface of the fixing belt 301 to smoothly slide the fixing belt 301 over the sliding member 304. Examples of the lubricant include silicone oil.

As described above, in the present exemplary embodiment, the frictional force between the fixing pad 303 and the fixing belt 301 is reduced by the sliding member 304. In the sliding member 304 according to the present exemplary embodiment, protrusion portions are provided to a sliding surface sliding over the fixing belt 301 as illustrated in FIG. 2B.

The sliding member 304 is made of metal, such as SUS, copper, and aluminum. The sliding member 304 desirably has a small heat capacity because the sliding member 304 comes into contact with the fixing belt 301 which is to be heated. Thus, in the present exemplary embodiment, the sliding member 304 is made of SUS having a thickness of 1 mm. The material of the sliding member 304 is not limited to the metal, and the sliding member 304 may be made of engineering plastic, such as a PI resin, a polyether ether ketone (PEEK) resin, and an LCP resin.

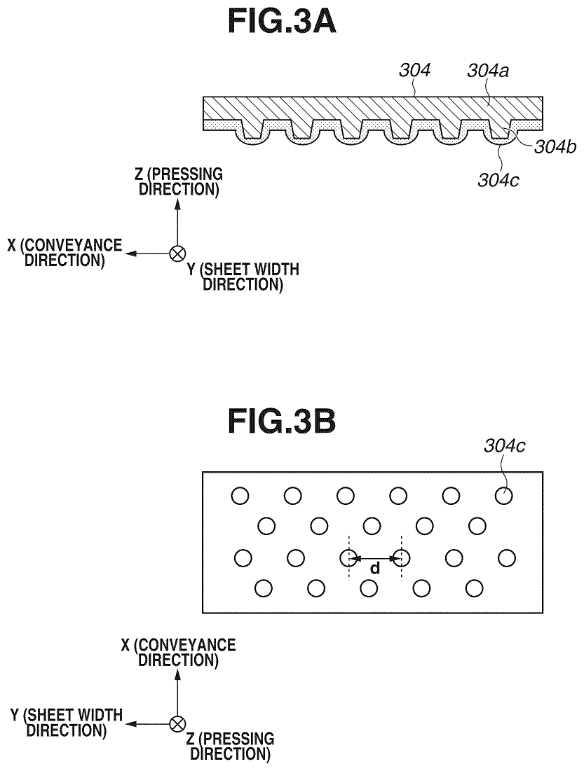

As illustrated in FIGS. 3A and 3B, the sliding member 304 includes a base member 304a having a plate shape, and a plurality of protrusion portions 304b serving as a sliding portion that protrude from the base member 304a and slides over the fixing belt 301. As illustrated in FIG. 3A, the protrusion portions 304b protrude from a surface of the base member 304a. A protrusion amount (height in Z direction) of each of the protrusion portions 304b from the surface of the base member 304a is, for example, 250 μm. As illustrated in FIG. 3B, the protrusion portions 304b are arranged at substantially equal intervals in the conveyance direction and in the width direction on the base member 304a. An interval d between the protrusion portions 304b adjacent to each other is, for example, 1.4 mm in both the conveyance direction and the width direction.

Further, a low friction layer 304c that is made of, for example, a polytetrafluoroethylene (PTFE) resin or PFA, and reduces the frictional force that is exerted with the fixing belt 301 is provided to the surface of the sliding member 304. In the present exemplary embodiment, surfaces of the base member 304a and the protrusion portions 304b are coated with PTFE having a thickness of 20 μm.

As illustrated in FIG. 4, in the present exemplary embodiment, the protrusion portions 304b are provided to the surface of the sliding member 304, and the sliding member 304 slides over the fixing belt 301 via front end surfaces of the protrusion portions 304b. This reduces a contact area between the sliding member 304 and the fixing belt 301 and reduces the frictional force that is exerted with the fixing belt 301. Since the surfaces of the protrusion portions 304b are coated with the low friction layer 304c as described above, the frictional force that is exerted with the fixing belt 301 is also reduced by the low friction layer 304c.

As described above, the fixing pad 303 holds the sliding member 304 in such a manner that the inner peripheral surface of the fixing belt 301 slides over the front end surfaces of the protrusion portions 304b. For this configuration, the fixing pad 303 includes the fitting groove portion 303f that is a depression and fits to and holds the sliding member 304, on a side opposite to a side supported by the fixing stay 302.

In a state in which the fixing nip portion N is formed, the fixing belt 301 slides over the protrusion portions 304b of the sliding member 304, and the sliding member 304 receives rubbing force toward the downstream side in the conveyance direction of the recording medium, with rotation of the pressing roller 305. At this time, a downstream abutting portion 304e of the base member 304a of the sliding member 304 abuts on a downstream side surface 303e that is provided to the fixing pad 303 and is downstream from the fitting groove portion 303f. As a result, the position of the sliding member 304 in the conveyance direction of the recording medium is fixed relative to the fixing pad 303. The downstream side surface 303e of the fixing pad 303 is provided continuously from the downstream-side guide portion 303b with a corner 303k having an arc shape in between. As a result, the fixing belt 301 continuously comes into contact with the sliding member 304 and the fixing pad 303, whereby the fixing belt 301 is guided.

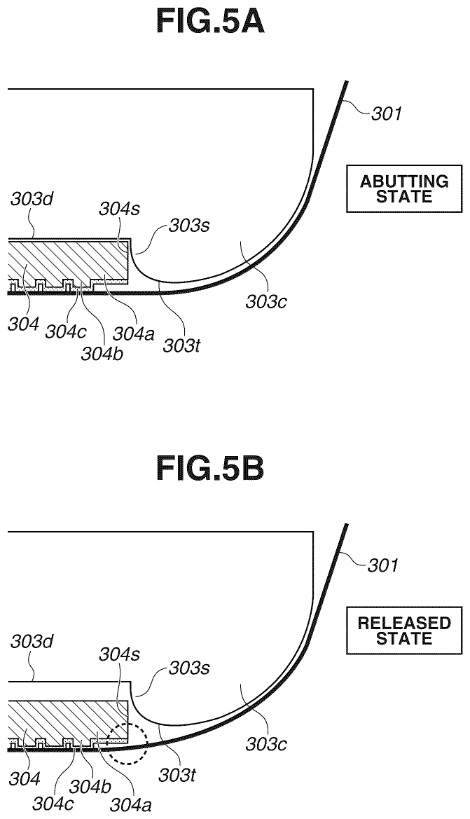

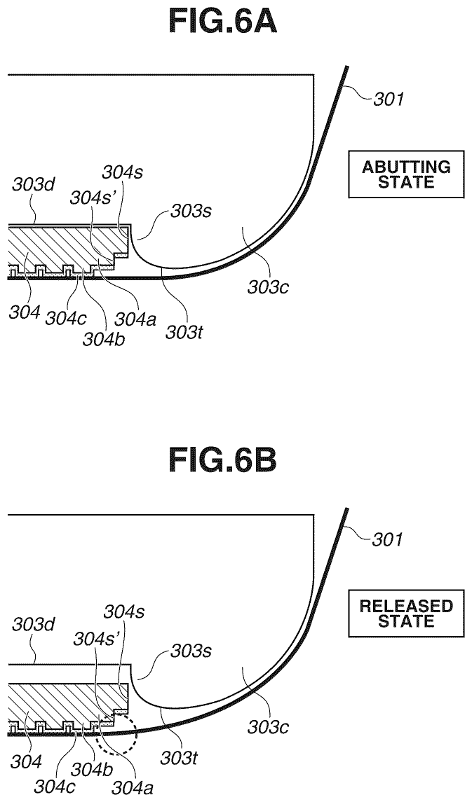

The upstream and downstream steps 304s′ and 304e′ provided to the sliding member 304 are described with reference to FIGS. 5A and 5B and FIGS. 6A and 6B.

FIG. 5A is a diagram illustrating, in a case where the above-described upstream and downstream steps 304s′ and 304e′ are not provided, a state where the fixing nip portion N is formed (so-called abutting state), and FIG. 5B is a diagram illustrating a state where the pressing roller 305 is separated from the fixing belt 301, and the fixing nip portion N is released (so-called released state). In the present exemplary embodiment, the relevant regions have a structure symmetrical between the upstream side and the downstream side. Therefore, only the upstream step 304s′ is illustrated in FIG. 5 for simplification.

In FIG. 5B in the released state, a corner (part surrounded by dashed line in FIG. 5) of the sliding member 304 overlaps with a path of the fixing belt 301. In the released state, the sliding member 304 is held by the fixing pad 303 with a gap in a perpendicular direction to avoid expansion deformation caused by thermal expansion. Thus, when the fixing nip portion N is released, the sliding member 304 maintains contact with the fixing belt 301 and is moved in a direction separating from the fixing pad 303. As a result, the corner of the sliding member 304 and the fixing belt 301 come close to each other.

FIG. 6B is also a diagram illustrating the released state, however, the upstream step 304s′ (downstream step 304e′) according to the present exemplary embodiment is provided, and the fixing belt 301 and the sliding member 304 appropriately maintain a distance. In the present exemplary embodiment, the upstream step 304s′ (downstream step 304e′) has a dimension of 400 μm in the pressing direction and 800 μm in the transverse direction, and has a uniform shape in the longitudinal direction.

With this configuration, by providing the upstream step 304s′ and the downstream step 304e′ in the sliding member 304, contact between the fixing belt 301 and the corners of the sliding member 304 is prevented, which prevents breakage.

The shape of each of the upstream step 304s′ and the downstream step 304e′ is not limited to the above-described shape, and the upstream step 304s′ and the downstream step 304e′ may have any structure by which the distance between the fixing belt 301 and the corners of the sliding member 304 is appropriately maintained.

### <Shape of Longitudinal End Region of Sliding Member>

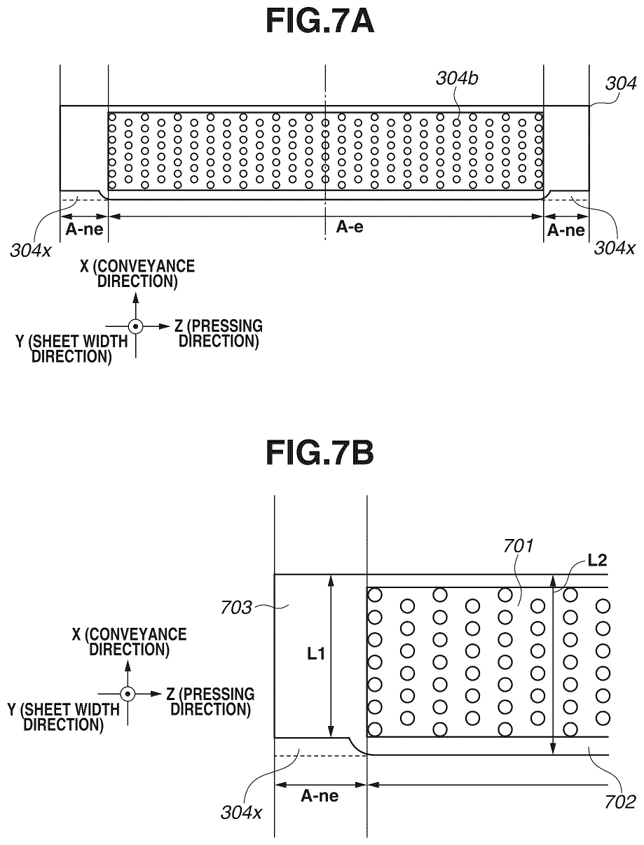

FIG. 7A is a diagram illustrating a longitudinal layout of the sliding member 304 as viewed from a lower side in the pressing direction. An A-e region illustrated in FIG. 7A is a region where the protrusion portions 304b are distributed. A-ne regions illustrated in FIG. 7A are regions where the protrusion portions 304b are not distributed on the sliding member 304. In the present exemplary embodiment, a width of the A-e region is set to 350 mm, and a width of each of the A-ne regions is set to 15 mm.

The reason why the A-ne regions are set is to prevent the lubricant and abrasion powder conveyed by the inner peripheral surface of the fixing belt 301 from coming around to the outer peripheral surface of the fixing belt 301. If the protrusion portions 304b are distributed in the A-ne regions, for example, a flow path climbing over the protrusion portions 304b and a flow path bypassing the protrusion portions 304b are formed when the lubricant reaches the protrusion portions 304b. The lubricant flowing into the flow path bypassing the protrusion portions 304b remains on the protrusion portions 304b, the lubricant remaining on the protrusion portions 304b adheres to end surfaces of the fixing belt 301, and the lubricant come around to the outer peripheral surface of the fixing belt 301. Even in a case where the fixing belt 301 is subjected to deviation position control, both end parts of the fixing belt 301 do not enter the A-ne regions, and are constantly positioned in the respective A-ne regions or at end parts outside the A-ne regions.

Thus, the A-ne regions where the protrusion portions 304b are not distributed are provided to form a structure in which the lubricant, the abrasion powder, and the like does not remain at positions coming into contact with the end surfaces of the fixing belt 301. This prevents the lubricant, the abrasion powder, and the like from coming around to the outer peripheral surface of the fixing belt 301.

Further, in the present exemplary embodiment, cutout parts 304x are provided to upstream parts of the A-ne regions of the sliding member 304. The reason of such a shape is as follows. Due to the A-ne regions, the protrusion portions 304b supporting the fixing belt 301 are absent, and the path of the fixing belt comes close to the sliding member 304. Therefore, such a shape is provided in order to prevent contact between the fixing belt 301 and the corners of the sliding member 304. A possibility of breakage of the fixing belt 301 caused by contact with the corner is high on the upstream side on which the fixing belt 301 enters the fixing nip portion N, as compared with the downstream side on which the fixing belt 301 is separated from the fixing nip portion N. Therefore, in the present exemplary embodiment, an example in which the cutout parts are provided at least on the upstream side is described. However, in a case where breakage of the fixing belt 301 occurs due to contact with the corner on the downstream side because of balance with the other member forming the nip, the cutout parts may be provided only on the downstream side. In the present exemplary embodiment, each of the cutout parts 304x is formed by cutting the sliding member 304 by 14.5 mm from a longitudinal end part toward a center and by 1.5 mm in the transverse direction, and the cutout parts having a similar shape are provided at both longitudinal end parts. While, in the present exemplary embodiment, each of the cutout parts is formed by cutting the sliding member 304 by 1.5 mm in the transverse direction, the cutout length is not limited to it as long as each of the cutout parts is formed by cutting the sliding member 304 by 3% or more of the dimension of the sliding member 304 in the transverse direction. The reason why the cutting dimension is set to 3% is because the step of 0.8 mm is provided in the transverse direction, and it is necessary to provide the cutout parts at least greater than the step. More desirably, each of the cutout parts is formed by cutting the sliding member 304 by 5% to 6% of the dimension of the sliding member 304.

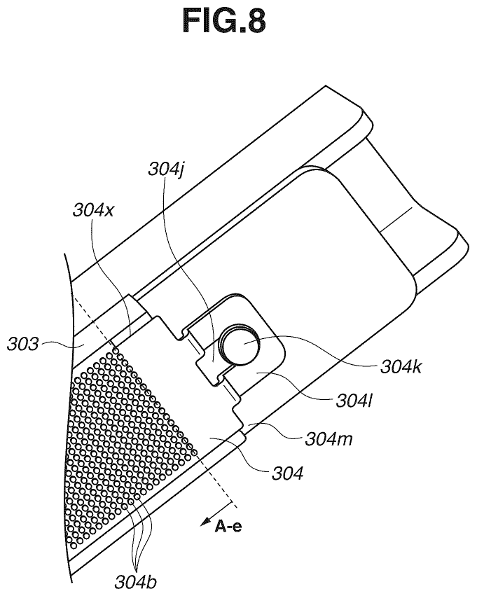

FIG. 7B is an enlarged view illustrating an end part of one of the A-ne region of the sliding member 304. A region 701 is a surface where the protrusion portions 304b as the sliding portion protrude from the base member 304a of the sliding member 304. A region 702 is a surface where the step is provided. A region 703 is a surface including the longitudinal end part of the sliding member 304 and where no protrusion portion 304b is provided. The region 703 is the surface same as the base member 304a and is continuous with the region 701 where the protrusion portions 304b are provided. The region 703 is the surface same as the base member 304a as described above, however, the region 703 and the base member 304a may be slightly different in height from each other. The region 703 is not limited to the above-described surface as long as the region 703 is continuous with the region 701 and is not subjected to folding processing as illustrated by a region 304l in FIG. 8. While, in FIGS. 7A and 7B, the shape of the cutout part has the same length as the step in the transverse direction, the shape is not limited thereto. The cutout part may be deeper than the step in the transverse direction or may be shallower than the step in the transverse direction as long as the cutout part is formed by cutting the sliding member 304 by 3% or more of the dimension of the sliding member 304 in the transverse direction. A length L1 at a certain position in the region 703 as a first region in the conveyance direction of the recording medium is shorter than a length L2 at a certain position in the region 701 as a second region in the conveyance direction of the recording medium. In the conveyance direction, an upstream end at the certain position in the region 703 is positioned on the upstream of an upstream end at the certain position in the region 701.

FIG. 8 is a partial perspective view illustrating relationship between the fixing pad 303 and the sliding member 304.

The fixing belt 301 (not illustrated in FIG. 8) comes into contact with the sliding member 304 within the A-e region illustrated in the drawing and slides over the sliding member 304. The sliding member 304 is held by step-shaped fastening members 304 k through slits 304j outside the region where the sliding member 304 slides over the fixing belt 301.

The sliding member 304 is held by the step-shaped fastening members 304 k with a gap in the perpendicular direction of the fixing pad 303, in the rotation axis direction (width direction) and in the conveyance direction of the recording medium. Each of the slits 304j is formed by folding the sliding member 304 and has a step from the base member 304a in a plate-shape. Through the slits 304j, the sliding member 304 is attached to the fixing stay 302 with the step-shaped fastening members 304k, such as screws. Folded portion are the regions 304l as outside portions, and the regions 304l are provided to a rotation center side of the pressing roller 305 relative to the base member 304a in a plate-shape. Since the slits 304j are formed to have steps, the step-shaped fastening members 304 k is attached at a height lower than the fixing belt 301, and an assembling work and a disassembling work of the fixing belt 301 can be performed without detaching the step-shaped fastening members 304 k.

For example, as illustrated by regions 304m, an edge part of the base member 304a and an edge part of each of the cutout parts 304x may be chamfered or may have a curved shape.

### <Example and Comparative Example for Confirmation of Effect>

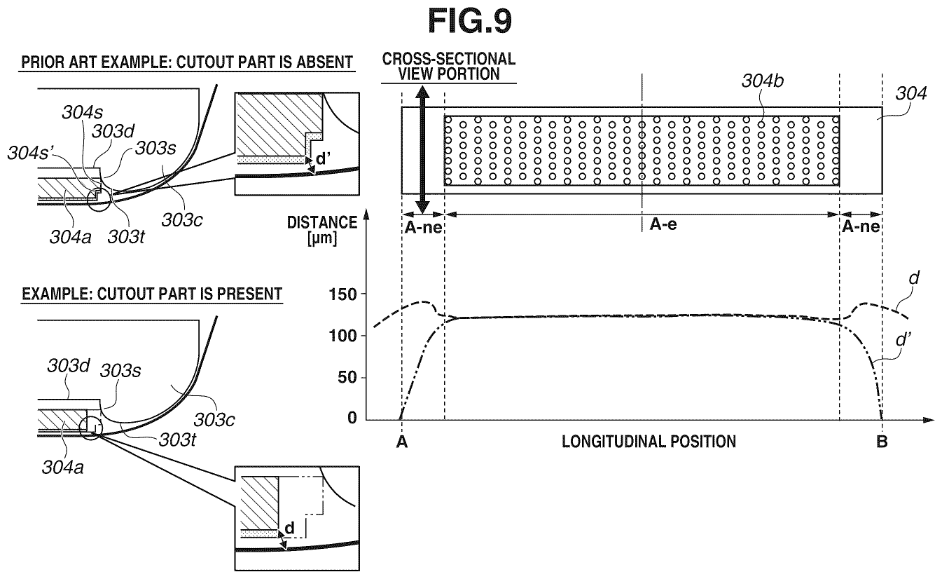

FIG. 9 is a graph illustrating relationship in a case where a proximity distance between the fixing belt 301 and the corner of the sliding member 304 including the cutout parts 304x in the A-e region and the A-ne regions is denoted by d, and a distance between the fixing belt 301 and the corner of the sliding member 304 not including the cutout parts 304x in the A-e region and the A-ne regions is denoted by d′. A cross-sectional view illustrated on the left of the drawing is a cross-sectional view of a cross-sectional view portion illustrated on the upper right of the drawing. The distances d and d′ were measured from a front side in the conveyance direction at a plurality of positions in the longitudinal direction in a state where the fixing belt 301 of the fixing device 8 was detached. The measurement was performed using a measuring device of LJ-V7000 series manufactured by Keyence Corporation. Thereafter, similar measurement was performed in a state where the fixing belt 301 was attached, and a difference was calculated as data.

It was found from the measurement that, in the A-ne regions where the protrusion portions 304b were not distributed at the longitudinal end part, the proximity distance d′ was sharply reduced, and ends (points A and B in graph) of the corners of the sliding member 304 came into contact with the fixing belt 301. On the other hand, it was confirmed that, in a case of the proximity distance d, an appropriate distance was maintained even in the A-ne regions, the fixing belt 301 and the corners of the sliding member 304 did not come into contact with each other and had a sufficient distance.

As effect verification of the cutout parts 304x, the following durability evaluation was performed.

A service life of the fixing belt 301 was evaluated by using a printer (imagePRESS V1000 manufactured by Canon Inc.). A peripheral velocity of the pressing roller 305 mounted on the fixing device 8 was set to 450 mm/sec, and a temperature of the halogen heaters 306 was set to 190° C. The service life was determined using the following method. A procedure in which after 10 thousand sheets of a printing pattern were continuously printed, the printer was turned off, the fixing belt 301 was checked, and then ten thousand sheets were continuously printed again was repeated. The number of passing sheets until a crack occurred on the fixing belt 301 was defined as the service life. Occurrence of breakage of the fixing belt 301 was determined by visually checking the end parts of the fixing belt 301. The maximum number of durable sheets was set to 10 million sheets, and the fixing belt 301 durable to printing of 10 million sheets was defined as the fixing belt 301 achieving a target. A temperature and humidity condition during the measurement was set to 23° C. and 30%. In the evaluation, the used sheet was an A4-size sheet of CS-680 (manufactured by Canon Inc.).

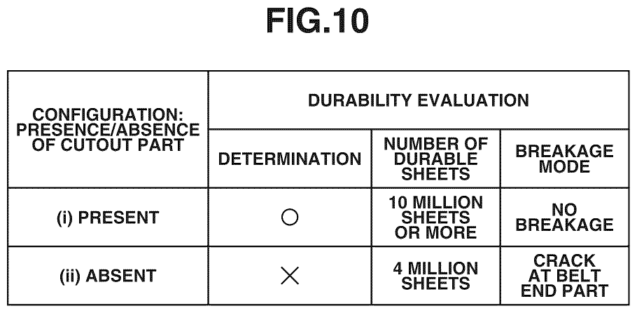

FIG. 10 is a table illustrating results of the durability evaluation. (i) In the fixing device 8 including the cutout parts 304x, breakage of the fixing belt 301 was not observed even after 10 million sheets were printed, and the target was achieved. (ii) In the verification performed with the sliding member not including the cutout parts 304x was mounted, breakage of the base layer was observed at the end part of the fixing belt 301 after 4 million sheets were printed. The breakage position of the fixing belt 301 was at the longitudinal end part, and an abrasion mark that might be caused by contact with the fixing belt 301 was observed in the sliding member 304 at a position corresponding to the breakage position of the fixing belt 301. Therefore, it was considered that the inner peripheral surface of the fixing belt 301 intermittently rubbed by contact with the sliding member 304 at the corresponding position, which led to abrasion and breakage of the base layer of the fixing belt 301.

Accordingly, as described in the present exemplary embodiment, by providing the cutout parts 304x on the sliding member 304, contact between the fixing belt 301 and the corners of the sliding member 304 is avoided, and breakage of the fixing belt 301 is prevented, which significantly improves the service life of the fixing belt 301.

While, in the present exemplary embodiment, the distance between the fixing belt 301 and the corners of the sliding member 304 is small in the released state as compared with the abutting state, depending on the configuration, the distance in the abutting state may be small as compared with the released state. Even in this case, providing the cutout parts 304x makes it possible to increase the distance between the fixing belt 301 and the corners of the sliding member 304, and contact between the fixing belt 301 and the corners of the sliding member 304 can be avoided.

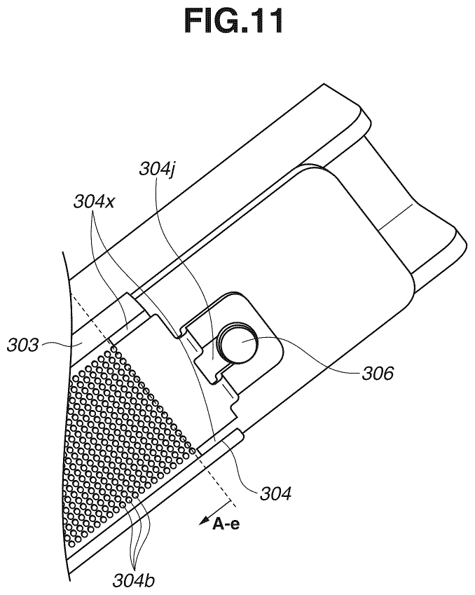

While, in the present exemplary embodiment, the case where the cutout parts 304x are provided to the upstream parts is described, cutout parts may be provided to downstream parts under a similar condition as illustrated in FIG. 11. In this case, the service life of the fixing belt 301 can be further improved. Referring to FIG. 7B, in a case where the cutout parts are provided to the downstream parts, in the conveyance direction, a downstream end at the certain position in the region 703 is positioned on the upstream from a downstream end at the certain position in the region 701.

While, in the present exemplary embodiment, the cutout parts 304x are provided in the A-ne regions, the cutout parts may extend to the A-e region. In this case, since the corners of the sliding member 304 have the positioning function through abutment on the upstream and downstream side as described above, a part other than the cutout parts 304x may be at at least any position in the longitudinal direction in the A-e region.

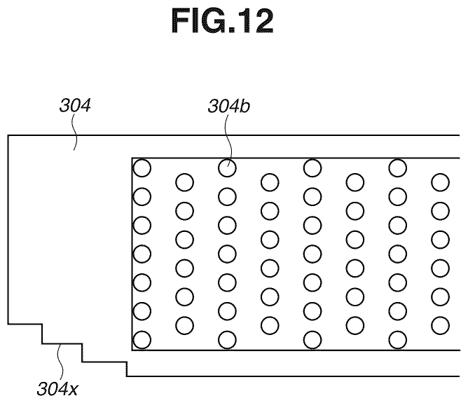

The cutout amount of each of the cutout parts 304x is not particularly limited to be constant, and each of the cutout parts 304x may have a plurality of cutout amounts in the longitudinal direction as illustrated in FIG. 12.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2024-101224, filed Jun. 24, 2024, which is hereby incorporated by reference herein in its entirety.

What is claimed is:

1. A fixing device comprising:
a belt configured to be rotatable and endless;
a rotation member configured to abut on an outer peripheral surface of the belt; and
a nip formation member provided on an inner peripheral surface of the belt to interpose the belt between the nip formation member and the rotation member, and configured to form a nip portion, the nip portion fixing a toner image to a recording medium by applying heat and pressure while holding and conveying the recording medium on which the toner image is formed,
wherein the nip formation member includes a sliding member that slides over the belt, on a surface coming into contact with the inner peripheral surface of the belt,
wherein the sliding member includes a base member and a sliding portion in which a plurality of protrusions protruding from the base member slides over the inner peripheral surface of the belt, a first region that is a surface where the sliding portion including the plurality of protrusions protruding from the base member is provided at a center part of the sliding member in a longitudinal direction, and a second region that is a surface same as the base member of the first region, disposed outside the first region in the longitudinal direction, and not including the sliding portion, and
wherein, in a conveyance direction of the recording medium, an upstream end at a first position in the first region is positioned upstream of an upstream end at a second position in the second region.

2. The fixing device according to claim 1, wherein, in the conveyance direction of the recording medium, a downstream end at the first position in the first region is positioned downstream of a downstream end at the second position in the second region.

3. The fixing device according to claim 1, wherein the sliding portion includes a plurality of protruded shapes.

4. The fixing device according to claim 1, wherein the sliding member includes a step formed in a direction orthogonal to the conveyance direction, extending longitudinally along an upstream end part in the conveyance direction.

5. The fixing device according to claim 1, wherein the sliding member includes a step formed in a direction orthogonal to the conveyance direction, extending longitudinally along a downstream end part in the conveyance direction.

6. The fixing device according to claim 1, wherein an end part of the sliding member in the longitudinal direction has a curved shape.

7. The fixing device according to claim 1,
wherein the sliding member includes an outside portion provided outside the second region in the longitudinal direction, and
wherein the outside portion is close to a rotation center of the rotation member relative to the second region in a direction perpendicular to a surface same as the base member.

8. The fixing device according to claim 7, wherein the sliding member is supported by another member configuring the nip formation member at the outside portion.

9. A fixing device comprising:
a belt configured to be rotatable and endless;
a rotation member configured to abut on an outer peripheral surface of the belt; and
a nip formation member provided on an inner peripheral surface of the belt to interpose the belt between the nip formation member and the rotation member, and configured to form a nip portion, the nip portion fixing a toner image to a recording medium by applying heat and pressure while holding and conveying the recording medium on which the toner image is formed,
wherein the nip formation member includes a sliding member that slides over the belt, on a surface coming into contact with the inner peripheral surface of the belt,
wherein the sliding member includes a base member and a sliding portion in which a plurality of protrusions protruding from the base member slides over the inner peripheral surface of the belt, a first region that is a surface where the sliding portion including the plurality of protrusions protruding from the base member is provided at a center part of the sliding member in a longitudinal direction, and a second region that is a surface same as the base member of the first region, disposed outside the first region in the longitudinal direction, and not including the sliding portion, and
wherein, in a conveyance direction of the recording medium, a downstream end at a first position in the first region is positioned downstream of a downstream end at a second position in the second region.
